(19) United States
(12) Patent Application Publication
(10) Pub. No.: US 2016/0187664 A1
(43) Pub. Date: Jun. 30, 2016

(54) LENS PANEL, THREE-DIMENSIONAL DISPLAY PANEL AND IMAGE UNIT THEREOF

(71) Applicant: Shenzhen China Star Optoelectronics Technology Co. Ltd., Shenzhen, Guangdong (CN)

(72) Inventor: Jianhong CHEN, Shenzhen, Guangdong (CN)

(21) Appl. No.: 14/416,537

(22) PCT Filed: Jan. 5, 2015
(86) PCT No.: PCT/CN2015/070084

§ 371 Date: Jan. 22, 2015

(30) Foreign Application Priority Data
Dec. 26, 2014 (CN) 201410828723.0

(51) Int. Cl. G02B 27/22; G02B 3/00; G02B 5/20; G02B 27/60

(52) U.S. Cl. CPC G02B 27/2214; G02B 27/60; G02B 3/0056; G02B 5/201

(57) ABSTRACT

A lens panel and a three-dimensional display panel are provided. The lens panel includes a lens array and a color-resist array. The lens array includes a lens. The color-resist array includes a red color-resist unit, a green color-resist unit and a blue color-resist unit. The red color-resist unit, green color-resist unit and blue color-resist unit are arranged in an array. The present invention can at least diminish color moire patterns generated by the three-dimensional display panel during displaying an image and increase a viewing angle.

### TECHNICAL FIELD OF THE INVENTION

The present invention relates to a display technology, and in particular to a lens panel and a three-dimensional display panel.

### BACKGROUND OF THE INVENTION

Conventional three-dimensional (3D) display panel generally includes a display panel and a lens panel, and the lens panel and the display panel are laminated into one body. In general, one lens covers one image unit, and the image unit includes a plurality of pixels or sub pixels. Multiple image units constitute an image displayed on the display panel. The lens panel projects the image of the display panel into space in a specific manner (for example, an orthogonal projection or perspective projection) for restoring a 3D scene. The human eye in a particular location or viewing region can perceive the 3D scene and experience at least binocular parallax, motion parallax, and other depth cues.

The lens panel herein includes at least two lenses, and the at least two lenses are disposed side by side.

On one hand, since the configuration of the sub pixels (e.g. R, G, and B sub pixels) of the panel and spacing bars of a black matrix (BM) has a periodicity, the configuration of the lenses in lens panel also has the periodicity. When the human eye views the display panel via the lenses, the neighboring lenses will appear the same color, and then there will be color patches and dark lines, i.e. a color moire pattern and a brightness moire pattern. The former reflects color unevenness, and the latter reflects brightness unevenness. Both are collectively referred to as moire patterns. It seriously affects the display quality of the three-dimensional display.

On the other hand, one lens often corresponds to one image unit whose size is equal thereto, and the size of the image unit basically determines a viewing angle of the 3D display. Thus, the viewing angle of the 3D display is restricted to the size of the image unit.

Therefore, there is a significant need to provide a new technical solution for solving the above-mentioned technical problem.

### SUMMARY OF THE INVENTION

An objective of the present invention is to provide a lens panel, a three-dimensional display, and an image unit thereof, which can at least diminish the color moire patterns and improve the viewing angle.

To achieve the foregoing objective, the technical solution of the present invention is as follows: a lens panel, comprising: a lens array, the lens array comprising: at least two lenses, the at least two lenses arranged in a first array; a color-resist array, the color-resist array comprising: at least one red color-resist unit; at least one green color-resist unit; and at least one blue color-resist unit; wherein the at least one red color-resist unit, at least one green color-resist unit, and the at least one blue color-resist unit are arranged in a second array.

In the above-mentioned lens panel, the color-resist array is utilized to blend a first image, which corresponds to moire patterns generated form a display panel during displaying an image, with a second image such that the first image is hidden by the second image, wherein the second image is formed by the red color-resist unit, the green color-resist unit, and the blue color-resist unit.

In the above-mentioned lens panel, the red color-resist unit corresponds to a part of the lens, the green color-resist unit corresponds to a part of the lens, and the blue color-resist unit corresponds to a part of the lens.

In the above-mentioned lens panel, the lens includes a first region, a second region, and a third region. Each of the first region, the second region, and the third region makes up one-third of area of the lens. The red color-resist unit is located in a position corresponding to the first region; the green color-resist unit is located in a position corresponding to the second region; and the blue color-resist unit is located in a position corresponding to the third region.

In the above-mentioned lens panel, the red color-resist unit corresponds to at least one lens; the green color-resist unit corresponds to at least one lens; and the blue color-resist unit corresponds to at least one lens.

In the above-mentioned lens panel, the color-resist array is integrated within the lens array.

In the above-mentioned lens panel, the lens array includes a lens layer and a base layer, and the color-resist array is disposed between the lens array and the base layer.

In the above-mentioned lens panel, the color-resist array and the lens array are laminated into one body.

In the above-mentioned lens panel, a shape of the lens is configured to be linear, and at least two linear lenses are disposed side by side. There is an angle defined between a line which is defined by the lens and a scan line in a display panel, wherein the angle ranges from 0 to 90 degrees.

A three-dimensional display panel includes: a display panel; and lens panel, the lens panel including: a lens array, the lens array comprising: at least two lenses, the at least two lenses arranged in a first array; a color-resist array, the color-resist array comprising: at least one red color-resist unit; at least one green color-resist unit; and at least one blue color-resist unit; wherein the at least one red color-resist unit, at least one green color-resist unit, and the at least one blue color-resist unit are arranged in a second array.

In the above-mentioned three-dimensional display panel, the color-resist array is utilized to blend a first image, which corresponds to moire patterns generated form a display panel during displaying an image, with a second image such that the first image is hidden by the second image, wherein the second image is formed by the red color-resist unit, the green color-resist unit, and the blue color-resist unit.

In the above-mentioned three-dimensional display panel, the red color-resist unit corresponds to a part of the lens, the green color-resist unit corresponds to a part of the lens, and the blue color-resist unit corresponds to a part of the lens.

In the above-mentioned three-dimensional display panel, the lens includes a first region, a second region, and a third region. Each of the first region, the second region, and the third region makes up one-third of area of the lens. The red color-resist unit is located in a position corresponding to the first region; the green color-resist unit is located in a position corresponding to the second region; and the blue color-resist unit is located in a position corresponding to the third region.

In the above-mentioned three-dimensional display panel, the red color-resist unit corresponds to at least one lens; the green color-resist unit corresponds to at least one lens; and the blue color-resist unit corresponds to at least one lens.

In the above-mentioned three-dimensional display panel, the color-resist array is integrated within the lens array.

In the above-mentioned three-dimensional display panel, the lens array includes a lens layer and a base layer, and the color-resist array is disposed between the lens array and the base layer.

In the above-mentioned three-dimensional display panel, the color-resist array and the lens array are laminated into one body.

In the above-mentioned three-dimensional display panel, a shape of the lens is configured to be linear, and at least two linear lenses are disposed side by side. There is an angle defined between a line which is defined by the lens and a scan line in a display panel, wherein the angle ranges from 0 to 90 degrees.

There is an image unit in the above-mentioned display panel. A position of the image unit corresponds to a position of the lens, and an area of the image unit is larger than or equal to an area of the lens.

In the image unit of the above-mentioned display panel, the region display unit has a width in a direction perpendicular to the line defined by the lens being larger than a width of the lens in the direction.

In comparison with the prior art, the present invention can at least diminish the color moire patterns generated by the three-dimensional display panel during displaying the image, and increase the viewing angle.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a schematic drawing illustrating a three-dimensional display panel of the present invention;

FIG. 2 is a schematic drawing illustrating a lens panel of the three-dimensional display panel as shown in FIG. 1 according to a first embodiment;

FIG. 3 is a schematic drawing illustrating a lens panel of the three-dimensional display panel as shown in FIG. 1 according to a second embodiment; and

FIG. 4 is a schematic drawing illustrating a lens panel of the three-dimensional display panel as shown in FIG. 1 according to a third embodiment.

### DETAILED DESCRIPTION OF THE INVENTION

As used herein, the word “exemplary” means “serving as an example, instance, or illustration. In addition, the articles “a” and “an” as used in this application and the appended claims may generally be construed to mean “one or more” unless specified otherwise or clear from context to be directed to a singular form.

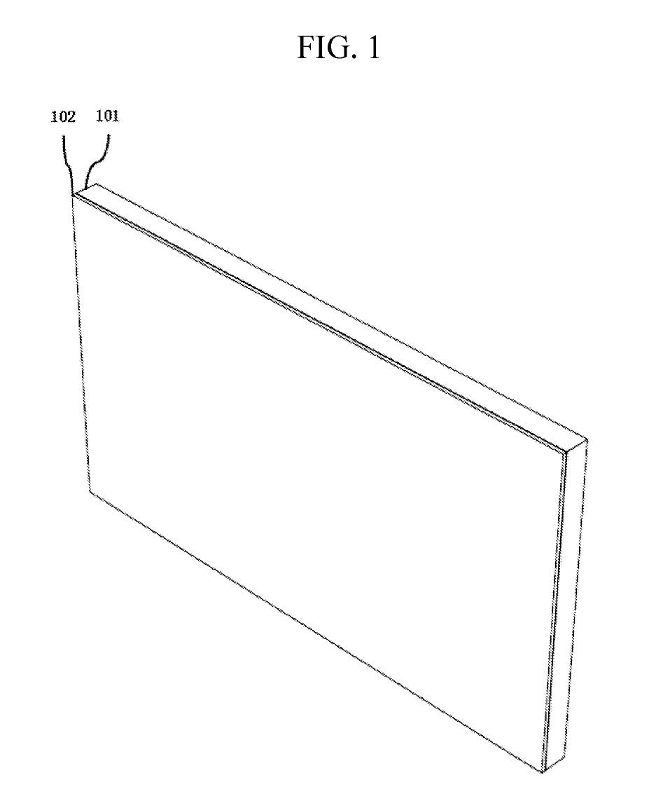

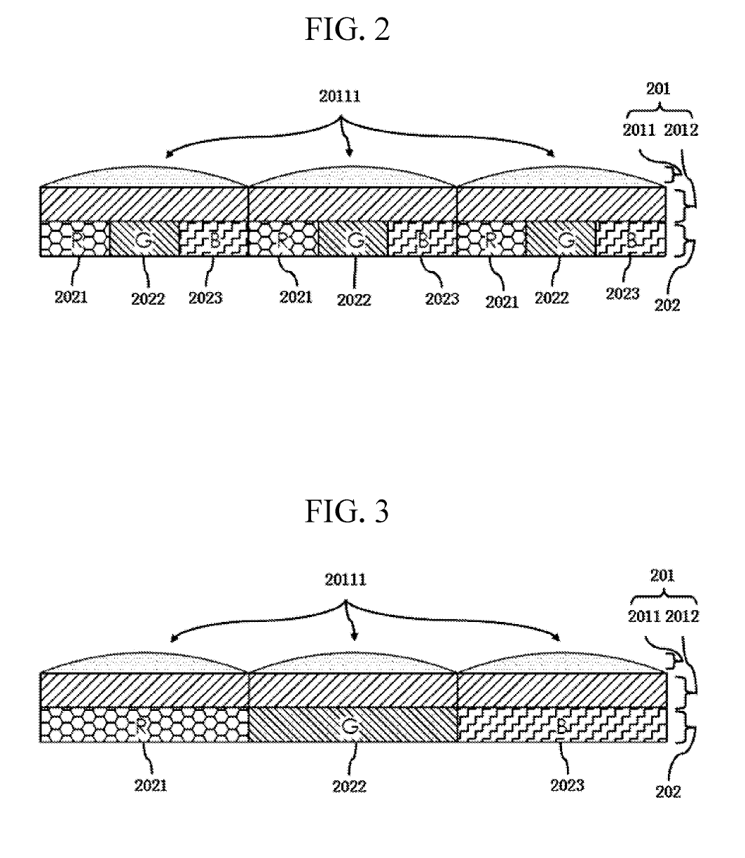

Referring to FIG. 1 and FIG. 2, FIG. 1 is a schematic drawing illustrating a three-dimensional display panel of the present invention, and FIG. 2 is a schematic drawing illustrating a lens panel 102 of the three-dimensional display panel as shown in FIG. 1 according to a first embodiment.

The three-dimensional display panel of the present invention includes a display panel 101 and a lens panel 102, and the display panel 101 and the lens panel 102 are laminated into one body. The display panel 101 herein can be a TFT-LCD (Thin Film Transistor Liquid Crystal Display) panel, an OLED (Organic Light Emitting Diode) display panel, and so on.

The display panel 101 is used to display an image. The lens panel 102 is used to construct the image displayed by the display panel 101 into a three-dimensional (3D) image. Specifically, the lens panel 102 is utilized to provide parallax of any directions, so that the three-dimensional display panel realizes autostereoscopic 3D display.

The lens panel 102 includes a lens array 201 and a color-resist array 202. The lens array 201 includes at least two lenses 20111, and at least two lenses 20111 are arranged in a first array. The color-resist array 202 includes at least one red color-resist unit 2021, at least one green color-resist unit 2022, and at least one blue color-resist unit 2023. The at least one red color-resist unit 2021, at least one green color-resist unit 2022, and the at least one blue color resisted unit 2023 are arranged in a second array.

The color-resist array 202 is utilized to diminish the color moire patterns generated by the display panel 101 during displaying the image, thereby improving the display quality. Specifically, the color-resist array 202 is utilized to blend a first image corresponding to the moire patterns with a second image such that the first image is hidden by the second image, that is, lowering detectability of the first image. The second image herein is formed by the red color-resist unit 2021, the green color-resist unit 2022, and the blue color-resist unit 2023.

The red color-resist unit 2021 has a red color resist material disposed therein; the green color-resist unit 2022 has a green color resist material disposed therein; and the blue color-resist unit 2023 has a blue color resist material disposed therein.

In the embodiment, the red color-resist unit 2021 corresponds to a part of the lens 20111; the green color-resist unit 2022 corresponds to a part of the lens 20111; and the blue color-resist unit 2023 corresponds to a part of the lens 20111. For instance, the lens 20111 includes a first region, a second region, and a third region. Each of the first region, the second region, and the third region makes up one-third of the area of the lens 20111. The red color-resist unit 2021 is located in a position corresponding to the first region; the green color-resist unit 2022 is located in a position corresponding to the second region; and the blue color-resist unit 2023 is located in a position corresponding to the third region. For another example, the lens 20111 includes a fourth region and a fifth region. The fourth region makes up two-thirds of the area of the lens 20111, and the fifth region makes up one-third of the area of the lens 20111. The red color-resist unit 2021 is located in a position corresponding to the fourth region of the lens 20111. The green color-resist unit 2022 is located in a position corresponding to the fifth region of the lens 20111 and another fifth region of another lens 20111 adjacent thereto. The blue color-resist unit 2023 is located in a position corresponding to another fourth region of another lens 20111, and so forth.

In the embodiment, the lens array 201 includes a lens layer 2011 and a base layer 2012. The lens layer 2011 is disposed on the base layer 2012, and the color-resist array 202 and the lens array 201 are laminated into one body. Specifically, the base layer 2012 of the lens array 201 is disposed on the color-resist array 202, and both are fixed to each other.

In the above-mentioned technical solution, since the lens panel 102 has the color-resist array 202 therein, at least color moire patterns generated by the display panel 101 during displaying the image can be diminished by the color-resist array 202. Thus, the display quality of the three-dimensional display panel can be enhanced. The corresponding image units of the three-dimensional display panel can be appropriately enlarged, thereby improving the viewing angle.

Furthermore, the lens 20111 is configured to be linear or dotted, and at least two linear or dotted lenses are disposed side by side. There is an angle defined between a line which is defined by one or more linear lenses 20111 and a scan line in the display panel 101. The angle ranges from 0 to 90 degrees. For example, The angle and be 10 degrees, 14 degrees, 17 degrees, 19 degrees, 21 degrees, 23 degrees, 26 degrees, 29 degrees, 31 degrees, 34 degrees, 36 degrees, 38 degrees, 40 degrees, 43 degrees, 45 degrees, 47 degrees, 50 degrees, 52 degrees, 55 degrees, 57 degrees, 59 degrees, 62 degrees, 66 degrees, 67 degrees, 69 degrees, 71 degrees, 73 degrees, 76 degrees, 78 degrees, 80 degrees and so on. Furthermore, there is the angle defined between the line which is defined by one or more linear lenses 20111 and the scan line in the display panel 101, and the angle ranges from 0 to 90 degrees, so the moire patterns will be further weakened when the display panel 101 displays the image, thereby improving the display quality of the three-dimensional display panel.

FIG. 3 is a schematic drawing illustrating a lens panel 102 of the three-dimensional display panel as shown in FIG. 1 according to a second embodiment. The difference between the embodiment and the first embodiment is that:

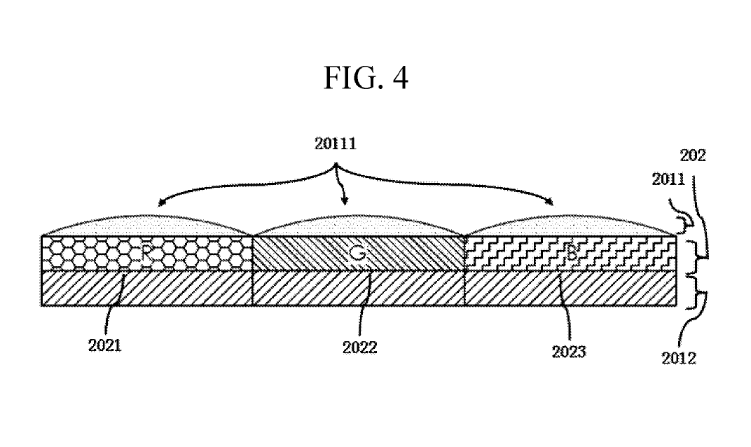

In the embodiment, the red color-resist unit 2021 corresponds to at least one lens 20111; the green color-resist unit 2022 corresponds to at least one lens 20111; and the blue color-resist unit 2023 corresponds to at least one lens 20111. For example, each of the red color-resist unit 2021, the green color-resist unit 2022 and the blue color-resist unit 2023 corresponds to one or two of the lenses 20111. FIG. 4 is a schematic drawing illustrating a lens panel 102 of the three-dimensional display panel as shown in FIG. 1 according to a third embodiment. The difference between the embodiment and the first or second embodiment is that:

In the embodiment, the color-resist array 202 is integrated within the lens array 201. For example, the color-resist array 202 is disposed between the lens array 2011 and the base layer 2012 of the lens array 201.

The position of the image unit in the three-dimensional display panel of the present invention corresponds to the position of the lens, and the area of image unit is larger than or equal to the area of the lens. That is, the position of the region display unit corresponding to the image unit corresponds to the position of the lens, and an area of the region display unit is larger than or equal to the area of the lens. Preferably, a shape of the image unit is equal to a shape of the lens. Alternatively, under the condition that the shape of the image unit is different from the shape of the lens, the image unit has a width in a direction perpendicular to the line defined by the lens being larger than a width of the lens in the direction. That is, the shape of the region display unit is the same as the shape of the lens. Alternatively, under the condition that the shape of the region display unit is different from the shape of the lens, the region display unit has a width in the direction perpendicular to the line defined by the lens being larger than the width of the lens in the direction.

Through the above technical solution, the display quality of the three-dimensional display panel can be increased.

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A lens panel, comprising:
a lens array, the lens array comprising:
at least two lenses, the at least two lenses arranged in a first array; and
a color-resist array, the color-resist array comprising:
at least one red color-resist unit;
at least one green color-resist unit; and
at least one blue color-resist unit;
wherein the at least one red color-resist unit, at least one green color-resist unit, and the at least one blue color-resist unit are arranged in a second array.

2. The lens panel according to claim 1, wherein the color-resist array is utilized to blend a first image, which corresponds to moire patterns generated form a display panel during displaying an image, with a second image such that the first image is hidden by the second image, wherein the second image is formed by the red color-resist unit, the green color-resist unit, and the blue color-resist unit.

3. The lens panel according to claim 1, wherein the red color-resist unit corresponds to a part of the lens, the green color-resist unit corresponds to a part of the lens, and the blue color-resist unit corresponds to a part of the lens.

4. The lens panel according to claim 3, wherein the lens comprises a first region, a second region, and a third region, each of the first region, the second region, and the third region makes up one-third of area of the lens, the red color-resist unit is located in a position corresponding to the first region, the green color-resist unit is located in a position corresponding to the second region, and the blue color-resist unit is located in a position corresponding to the third region.

5. The lens panel according to claim 1, wherein the red color-resist unit corresponds to at least one lens, the green color-resist unit corresponds to at least one lens, and the blue color-resist unit corresponds to at least one lens.

6. The lens panel according to claim 1, wherein the color-resist array is integrated within the lens array.

7. The lens panel according to claim 6, wherein the lens array comprises a lens layer and a base layer, the color-resist array disposed between the lens array and the base layer.

8. The lens panel according to claim 1, wherein the color-resist array and the lens array are laminated into one body.

9. The lens panel according to claim 1, wherein a shape of the lens is configured to be linear, at least two linear lenses are disposed side by side, and there is an angle defined between a line which is defined by the lens and a scan line in a display panel, wherein the angle ranges from 0 to 90 degrees.

10. A three-dimensional display panel, comprising:
a display panel; and
a lens panel, the lens panel comprising:
a lens array, the lens array comprising:
at least two lenses, the at least two lenses arranged in a first array;
a color-resist array, the color-resist array comprising:
at least one red color-resist unit;
at least one green color-resist unit; and
at least one blue color-resist unit;
wherein the at least one red color-resist unit, at least one green color-resist unit, and the at least one blue color-resist unit are arranged in a second array.

11. The three-dimensional display panel according to claim 10, wherein the color-resist array is utilized to blend a first image, which corresponds to moire patterns generated form the display panel during displaying an image, with a second image such that the first image is hidden by the second image, wherein the second image is formed by the red color-resist unit, the green color-resist unit, and the blue color-resist unit.

12. The three-dimensional display panel according to claim 10, wherein the red color-resist unit corresponds to a part of the lens, the green color-resist unit corresponds to a part of the lens, and the blue color-resist unit corresponds to a part of the lens.

13. The three-dimensional display panel according to claim 12, wherein the lens comprises a first region, a second region, and a third region, each of the first region, the second region, and the third region makes up one-third of area of the lens, the red color-resist unit is located in a position corresponding to the first region, the green color-resist unit is located in a position corresponding to the second region, and the blue color-resist unit is located in a position corresponding to the third region.

14. The three-dimensional display panel according to claim 10, wherein the red color-resist unit corresponds to at least one lens, the green color-resist unit corresponds to at least one lens, and the blue color-resist unit corresponds to at least one lens.

15. The three-dimensional display panel according to claim 10, wherein the color-resist array is integrated within the lens array.

16. The three-dimensional display panel according to claim 15, wherein the lens array comprises a lens layer and a base layer, the color-resist array disposed between the lens array and the base layer.

17. The three-dimensional display panel according to claim 10, wherein the color-resist array and the lens array are laminated into one body.

18. The three-dimensional display panel according to claim 10, wherein a shape of the lens is configured to be linear, at least two linear lenses are disposed side by side, and there is an angle defined between a line defined by the lens and a scan line in the display panel, wherein the angle ranges from 0 to 90 degrees.

19. An image unit in the three-dimensional display panel according to claim 10, wherein a position of the image unit corresponds to a position of the lens, and an area of the image unit is larger than or equal to an area of the lens.

20. The image unit in the three-dimensional display panel according to claim 19, wherein the region display unit has a width in a direction perpendicular to the line defined by the lens being larger than a width of the lens in the direction.
